(19) United States
(12) Patent Application Publication
(10) Pub. No.: US 2010/0154734 A1
(43) Pub. Date: Jun. 24, 2010

(54) Method of making a coated article

(76) Inventors: Jason L. Sebright, Chillicothe, IL (US); M. Brad Beardsley, Laura, IL (US); Ondrej Racek, Duniap, IL (US)

Correspondence Address: Caterpillar Inc.;Intellectual Property Dept., AH 9510, 100 N.E. Adams Street, PEORIA, IL, 61629-9510, US

(21) Appl. No.: 12/318,006

(22) Filed: Dec. 19, 2008

(51) Int. Cl. F02M 35/104; F16L 9/14; B29C 53/82

(52) U.S. Cl. 123/184.21; 156/155; 138/145

(57) ABSTRACT

In one aspect, the present disclosure is directed to a method of making a coated article. The method may include forming a sacrificial substrate in a predetermined shape corresponding with the shape of a final substrate. The method may also include applying a thermal spray coating to the sacrificial substrate. In addition, the method may include separating the thermal spray coating from the sacrificial substrate to obtain a formed sheet of coating material and affixing the formed sheet of coating material to a surface of the final substrate using an adhesive.

### TECHNICAL FIELD

The present disclosure is directed to a method of making a coated article and, more particularly, to a method of making a thermal spray coated article.

### BACKGROUND

Thermal spray coatings are commonly applied to substrates to enhance one or more properties of the substrates. For example, thermal spray coatings may enhance wear resistance/hardness, corrosion resistance, heat resistance, electrical conductivity or resistivity, abradability, abrasiveness, texture, catalytic properties, etc. Alternatively or additionally, thermal spray coatings may be used to restore dimension/surface contours of a substrate and/or to coat intricate surfaces.

An intermediate layer may be used between the substrate and the thermal spray coating. In some cases, the intermediate layer may contain particles that are hollow, dissolvable, or otherwise removable from the intermediate layer, and which, when removed, leave behind recesses that provide a mechanical interlock with the thermal spray coating. In other cases, an intermediate layer may be used to protect the substrate. For example, U.S. Patent Application Publication No. 2008/0107890 to Bureau et al. (the '890 publication) discloses a thermoplastic matrix used as a tie layer between a substrate and a thermal spray coating. The '890 publication discloses that the tie layer may be applied to the substrate to protect the substrate (e.g., from heat) during the thermal spray coating process.

The present disclosure is directed at improvements in existing methods of making coated articles.

### SUMMARY

In one aspect, the present disclosure is directed to a method of making a coated article. The method may include forming a sacrificial substrate in a predetermined shape corresponding with the shape of a final substrate. The method may also include applying a thermal spray coating to the sacrificial substrate. In addition, the method may include separating the thermal spray coating from the sacrificial substrate to obtain a formed sheet of coating material and affixing the formed sheet of coating material to a surface of the final substrate using an adhesive.

In another aspect, the present disclosure is directed to a coated article. The coated article may include a substrate and a plurality of pieces of pre-formed thermal spray coating sheets affixed to the substrate adjacent one another with an adhesive.

In another aspect, the present disclosure is directed to a method of making a coated article. The method may include forming, by powder metallurgy fabrication, one or more coating sheets in a predetermined shape corresponding with the shape of a substrate. In addition, the method may also include affixing the one or more coating sheets to a surface of the substrate using an adhesive.

### BRIEF DESCRIPTION OF THE DRAWINGS

FIG. 1 is a diagrammatic illustration of an exemplary sacrificial substrate.

FIG. 2 depicts a thermal spray coating process according to an exemplary disclosed method.

FIG. 3A depicts an exemplary method of separating a sacrificial substrate from a thermal spray coating.

FIG. 3B depicts an alternative method of separating a sacrificial substrate from a thermal spray coating.

FIG. 4 is a sheet of thermal spray coating material for application to a final substrate according to an exemplary disclosed method.

FIG. 5 depicts application of sheets of thermal spray coating material to an inner surface of a recess according to an exemplary disclosed embodiment.

FIG. 6 is a diagrammatic, perspective illustration of a coated article according to an exemplary disclosed embodiment.

### DETAILED DESCRIPTION

Reference will now be made in detail to the drawings. Wherever possible, the same reference numbers will be used throughout the drawings to refer to the same or like parts.

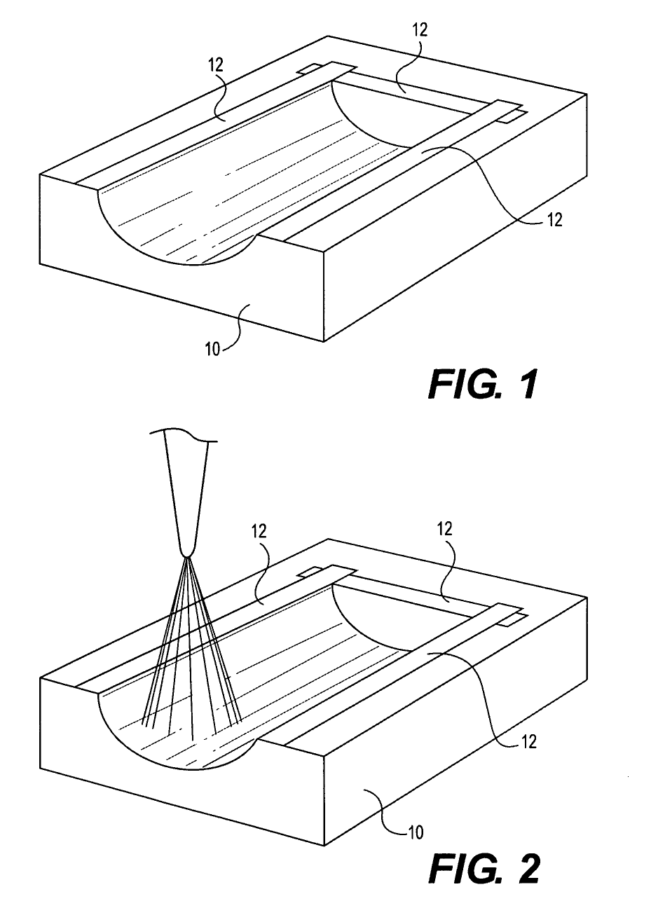

FIGS. 1-6 illustrate steps of a method of making a coated article. The method may involve forming a sacrificial substrate 10 in a predetermined shape corresponding with the shape of a final substrate. FIGS. 1-6 illustrate a method for coating an inner surface of a cylindrical recess or conduit. However, the disclosed method may be used to coat articles having any shape.

An exemplary sacrificial substrate 10 is illustrated in FIG. 1. Sacrificial substrate 10 may be formed in the same or similar manner that the final substrate is formed. For example, if the final substrate is formed with a mold, sacrificial substrate 10 may be formed from the same mold. Alternatively, if the final substrate is formed by a more complicated process, a mold of the final substrate may be made, and sacrificial substrate 10 may be formed using that mold. Further, any suitable method may be used to form sacrificial substrate 10.

Sacrificial substrate 10 shown in FIG. 1 is a mold replicating the inner surface of one half of a cylinder. In some embodiments, sacrificial substrate 10 may be masked in a suitable way. For example, a masking material 12 may be applied to establish the boundaries within which the thermal spray coating is desired to be applied to sacrificial substrate 10. Such masking may be configured to withstand the thermal spray coating procedure. An exemplary masking material 12 may include a metallic strip, other thermally resistant material, or any other suitable masking material taking into consideration the type of thermal spray coating process that will be used to apply the coating to sacrificial substrate 10.

As shown in FIG. 2, the method may also include applying a thermal spray coating to sacrificial substrate 10. The thermal spray coating may be applied by any appropriate thermal spray coating process, such as a high velocity oxygen fuel (HVOF) coating process (sometimes referred to as “high velocity oxy-fuel”), flame spraying, wire-arc spraying, plasma spraying, cold spraying, warm spraying, detonation spraying, etc.

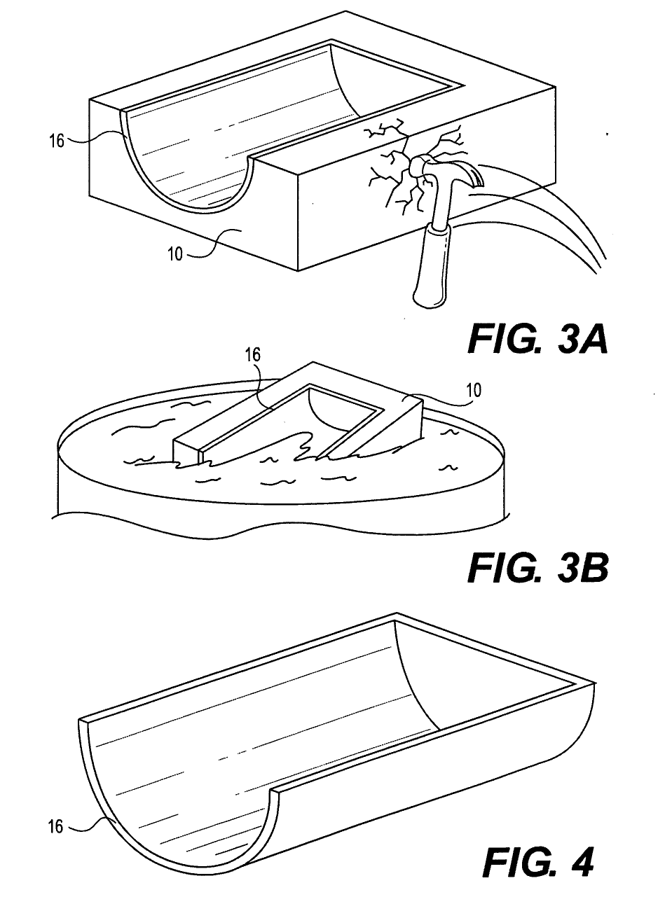

As shown in FIGS. 3A and 3B, the thermal spray coating process may be used to apply a thermal spray coating 14 to sacrificial substrate 10. In addition, as also shown in FIGS. 3A and 3B, the method may include separating thermal spray coating 14 from sacrificial substrate 10 to obtain a formed sheet 16 of coating material (see FIG. 4). In some cases, coating 14 may be separated from sacrificial substrate 10 mechanically. For example, coating 14 may be sheared, pried, or otherwise forceably separated from sacrificial substrate 10. In some embodiments, sacrificial substrate 10 may be shattered. FIG. 3A depicts a simplified example of separating coating 14 from sacrificial substrate 10. In such embodiments, sacrificial substrate 10 may be a brittle material. For example, in some embodiments, sacrificial substrate 10 may be a ceramic material and separating the coating from the sacrificial substrate may include fracturing the ceramic material (e.g., as shown in FIG. 3A).

To facilitate mechanical separation of coating 14 from sacrificial substrate 10, sacrificial substrate 10 may have a smooth surface. For example, in some embodiments, the surface of sacrificial substrate 10 may be polished. An exemplary polished finish may include a mirror-like, or chrome-like, metallic finish. Other exemplary polished finishes may include finely polished ceramic.

In some cases, separating coating 14 from sacrificial substrate 10 may include chemically dissolving sacrificial substrate 10 with a solvent in which the coating material is not soluble. For example, as shown in FIG. 3B, sacrificial substrate 10 may be dipped in a solvent. FIG. 3B is a somewhat simplified depiction of this step, and such a procedure may be carried out with appropriate handling and support of coating 14. In some embodiments, sacrificial substrate 10 may be aluminum, the solvent may include sodium hydroxide acid, and the thermal spray coating may be nickel chrome-chrome carbide.

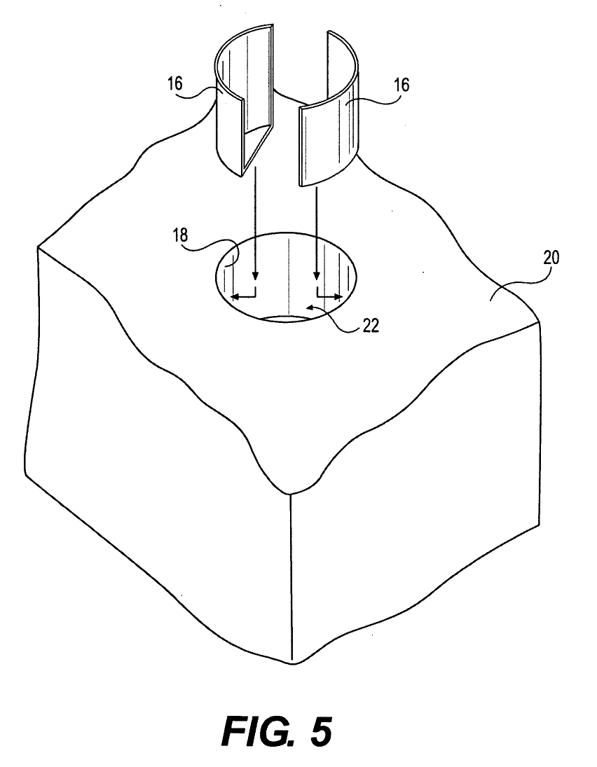

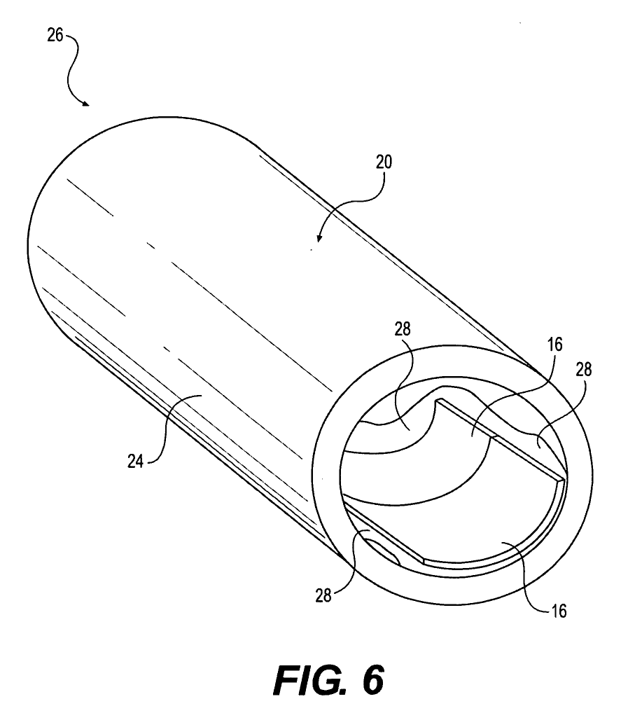

Once coating 14 is separated from sacrificial substrate 10, to obtain a formed sheet 16 of coating material, as shown in FIG. 4, one or more formed sheets 16 of coating material may be applied to a surface 18 of a final substrate 20 using an adhesive, as shown in FIG. 5. For example, multiple formed sheets 16 may be applied to coat the inner wall of a recess 22, as shown in FIG. 5, or of a hollow article, such as a conduit 24 (see FIG. 6). In some exemplary methods, the adhesive may be applied to final substrate 20 prior to affixing formed sheets 16 of coating material to final substrate 20. In other exemplary methods, the adhesive may be applied to formed sheets 16 of coating material prior to affixing formed sheets 16 of coating material to final substrate 20. In some embodiments, coating 14, the adhesive, and final substrate 20 may be pressed together and/or heated until the adhesive cures.

As an alternative, the disclosed method of making a coated article may implement powder metallurgy fabrication methods to create the coating sheets rather than thermal spray coating processes applied to sacrificial substrates. Powder metallurgy fabrication methods may involve shaping a quantity of metal powder particles into a particular form and then sintering the particles to form a metal article having that form. For example, metal injection molding (MIM) is a powder metallurgy fabrication method that may allow net-shape or near-net-shape production of components. MIM can produce components with complex shapes that would otherwise require extensive machining. MIM typically involves forming a mixture of MIM powders with a binder and injecting the mixture into a mold where the mixture takes form. The form is then ejected from, or otherwise separated from the mold (e.g., using separation methods disclosed herein), and the binder may be removed by a solvent and/or a thermal process. The resulting part may then be consolidated by sintering.

According to the methods disclosed herein, an article may be coated by forming, by powder metallurgy fabrication, one or more coating sheets in a predetermined shape corresponding with the shape of a substrate. The powdered metal coating sheets may then be affixed to a surface of the substrate using an adhesive in the same or similar manner described below with respect to embodiments formed using thermal spray coating techniques.

The adhesive used to affix formed sheets 16 of coating material to final substrate 20 may include any suitable adhesive for the environment. Since thermal spray coatings may be used to provide anti-corrosion, heat resistance, wear resistance, strength, and other purposes involving protection of substrates from harsh environmental conditions, the adhesive selected may have properties that enable the adhesive to withstand such conditions. In some embodiments, the adhesive may be a polymer adhesive. Exemplary polymer adhesives that may be used for the disclosed method may include Cytec FM® 1000, various versions of Scotch-weld™ 2214, etc.

FIG. 6 illustrates a coated article 26 in a partially assembled state, including final substrate 20 and a plurality of pieces of pre-formed thermal spray coating sheets 16 affixed to final substrate 20 adjacent one another with an adhesive 28. In some embodiments, final substrate 20 may be fully covered by coating sheets 16. In other embodiments, final substrate 20 may have select portions that are covered by coating sheets 16. In some applications, adjacent coating sheets may abut one another. In some embodiments, it may be desirable to fully protect final substrate 20 from harsh environmental conditions, such as moisture. For these and other applications, embodiments of coated article 26 may be coated such that adjoining edges of adjacent coating sheets overlap. Alternatively, or additionally, the adhesive may be applied to final substrate 20 prior to affixing coating sheets 16 to final substrate 20, in order to ensure that the surface of final substrate 20 is fully coated, thereby protecting it from harsh environmental conditions.

### INDUSTRIAL APPLICABILITY

The disclosed method may be applicable to make coated articles having certain properties. For example, thermal spray coatings, or powdered metal pre-formed coating sheets, as applied by the disclosed method, may provide substrate materials with resistance to corrosion, wear, heat, etc. Alternatively, or additionally, the disclosed method of making coated articles may provide such articles with electrical conductivity or resistivity, abradability, abrasiveness, texture, catalytic properties, and/or other desirable properties.

In some embodiments, the disclosed method may be applicable to create an article with a durable coating. For example, different types of coatings may bond to substrate materials with different strengths. In some cases, the properties of a particular coating (e.g., corrosion resistance) may be desired, but the durability of the coating may not be as high as desired. In such cases, the disclosed method may be utilized to affix the coating to the substrate using a high strength adhesive. The bonds between the adhesive and the substrate and between the adhesive and the coating may both be stronger than the bond that could be achievable between the coating and the substrate without adhesive. Therefore, by providing an intermediate adhesive layer, the coating may be affixed to the substrate with greater strength, thus providing the coating with durability.

In addition, the disclosed method may be applicable for providing a thermal spray coating, or powdered metal coating, on surfaces that are not accessible to coating equipment, such as thermal spray coating apparatus. For example, inner surfaces of various components, such as conduits, blind holes, crevices, recesses, and other hard or impossible to reach places may be coated using the disclosed method.

Exemplary substrates that may be coated in the disclosed manner may include components that may be exposed to harsh environments. For example, combustion engine intake systems may be exposed to moisture that can create a risk of corrosion in the intake system. In some embodiments, the disclosed method may be applicable for coating inner surfaces of various engine intake system components, such as air intake ducts and/or intake manifolds.

In other embodiments, the disclosed method may be used to apply a coating to engine exhaust system components, such as exhaust-carrying conduits, after-treatment components, such as catalytic converters and particulate traps, mufflers, etc., which may be exposed to not only moisture, but also considerable heat. In some embodiments, the disclosed method may be used to apply a thermal spray coating to an inner surface of one or more exhaust system components. In exhaust systems that implement after-treatment of exhaust gases (e.g., catalytic conversion, particulate filtration, etc.) exhaust temperatures may become significantly elevated. For example, the process of catalytic conversion, as well as the regeneration of particulate filters, may increase the temperatures of exhaust gases considerably. To protect exhaust components from these elevated temperatures and/or moisture, inner surfaces of exhaust components may be coated with a thermal spray coating using the methods disclosed herein.

In some embodiments, final substrate 20 may include an engine intake system component, such as an air intake duct or intake manifold. In such embodiments, coating sheets 16 may be affixed to an inner surface of the engine intake system component. In other embodiments, final substrate 20 may include an exhaust system component and the coating sheets 16 may be affixed to an inner surface of the exhaust system component. The exhaust system component may include, for example, an exhaust carrying conduit or after-treatment device, such as a catalytic converter, particulate trap, muffler, etc.

Although engine intake components and exhaust components are discussed herein as exemplary substrates, the disclosed methods may be used to affix thermal spray coatings to a wide variety of articles.

It will be apparent to those having ordinary skill in the art that various modifications and variations can be made to the disclosed method of making a coated article without departing from the scope of the disclosed embodiments. Other embodiments of the disclosed system will be apparent to those having ordinary skill in the art from consideration of the specification and practice of the concepts disclosed herein. It is intended that the specification and examples be considered as exemplary only, with a true scope of the disclosed embodiments being indicated by the following claims and their equivalents.

What is claimed is:

1. A method of making a coated article, comprising:
forming a sacrificial substrate in a predetermined shape corresponding with the shape of a final substrate;
applying a thermal spray coating to the sacrificial substrate;
separating the thermal spray coating from the sacrificial substrate to obtain a formed sheet of coating material; and
affixing the formed sheet of coating material to a surface of the final substrate using an adhesive.

2. The method of claim 1, wherein separating the thermal spray coating from the sacrificial substrate includes mechanically separating the coating from the sacrificial substrate.

3. The method of claim 2, wherein the surface of the sacrificial substrate to which the thermal spray coating is applied is polished.

4. The method of claim 1, wherein separating the coating from the sacrificial substrate includes chemically dissolving the sacrificial substrate with a solvent in which the coating material is not soluble.

5. The method of claim 4, wherein the sacrificial substrate is aluminum, the solvent includes sodium hydroxide acid, and the thermal spray coating is nickel chrome-chrome carbide.

6. The method of claim 1, wherein the sacrificial substrate is a ceramic material.

7. The method of claim 6, wherein separating the coating from the sacrificial substrate includes fracturing the ceramic material.

8. The method of claim 1, further including applying the adhesive to the final substrate prior to affixing the formed sheet of coating material to the final substrate.

9. The method of claim 1, further including applying the adhesive to the formed sheet of coating material prior to affixing the formed sheet of coating material to the final substrate.

10. The method of claim 1, wherein the adhesive is a polymer adhesive.

11. The method of claim 1, wherein the adhesive provides stronger bonding with the sheet of coating material and with the final substrate, than would be provided between the thermal spray coating and the final substrate if an adhesive were not used.

12. A coated article, comprising:
a substrate; and
a plurality of pieces of pre-formed thermal spray coating sheets affixed to the substrate adjacent one another with an adhesive.

13. The article of claim 12, wherein adjoining edges of adjacent coating sheets overlap.

14. The article of claim 12, wherein the adhesive is a polymer adhesive.

15. The article of claim 12, wherein the substrate includes an engine intake system component and the coating sheets are affixed to an inner surface of the engine intake system component.

16. The article of claim 12, wherein the substrate includes an exhaust system component and the coating sheets are affixed to an inner surface of the exhaust system component.

17. The article of claim 16, wherein the exhaust system component includes an exhaust carrying conduit.

18. The article of claim 12, wherein the substrate includes a recess and the thermal spray coating sheets are applied to an inner surface of the recess.

19. The article of claim 12, wherein the bonding between the thermal spray coating sheets and the adhesive and between the substrate and the adhesive is stronger than a bond that would be provided between the thermal spray coating and the substrate if an adhesive were not used.

20. A method of making a coated article, comprising:
forming, by powder metallurgy fabrication, one or more coating sheets in a predetermined shape corresponding with the shape of a substrate; and
affixing the one or more coating sheets to a surface of the substrate using an adhesive.
